(19) United States
(12) Patent Application Publication
(10) Pub. No.: US 2002/0069191 A1
(43) Pub. Date: Jun. 6, 2002

(54) Method and system for electronic self-monitoring of menstrual cycles

(76) Inventors: Eve E. Ellis, New York, NY (US); Annette Niemtzow, New York, NY (US)

Correspondence Address: DUANE MORRIS LLP, 100 COLLEGE ROAD WEST, SUITE 100, PRINCETON, NJ, 08540-6604, US

(21) Appl. No.: 09/971,995

(22) Filed: Oct. 5, 2001

Related U.S. Application Data
(60) Provisional application No. 60/239,292, filed on Oct. 11, 2000.

(51) Int. Cl. G06F 7/00

(52) U.S. Cl. 707/1

(57) ABSTRACT

A method and system for tracking a menstrual cycle of at least one female person using a suitable microprocessor based device. The method includes: recording and saving data associated with the menstrual cycle; recording and saving information on flow associated with the menstrual cycle; recording and saving information on moods associated with the person; and, recording and saving notes associated with the person or menstrual cycle. The menstrual cycle is automatically monitored and projections are made based upon at least a portion of the recorded and stored data associated the menstrual cycle.

### PRIORITY FILING

This application claims the benefit of the earlier filing date, under 35 U.S.C. 119, of commonly assigned provisional patent application, serial number 60/239,292 entitled “Method and System for Electronic Self-Monitoring of Menstrual Cycles,” filed on Oct. 11, 2000.

### FIELD OF INVENTION

The present invention relates generally to monitoring a menstrual cycle, and particularly to methods and systems for monitoring a menstrual cycle.

### BACKGROUND OF THE INVENTION

Traditionally, women all over the world devise individual methods for keeping track of their periods or are surprised by its arrival or non-arrival. Methods include writing down information on a paper calendar or making a mental note and hoping that one's memory the following month is accurate. Information gathered can be scattered, short-term, or inaccurate.

It is an object of the present invention to provide a system and method which monitors, using personal calendars and summaries for example, for an end user's period, ovulation, and pregnancy. There is a long-felt need for this for countless numbers of females, as young as 10 years old to those over the age of 50. It is a further object of the present invention that this system and method be able to be implemented on as many kinds of Personal Digital Assistants (PDAs) as possible using a common web site from which appropriate computer code, or instructions, such as that attached hereto as the sole Appendix, or other PDA application sites such as women centered web sites. It is a further object of the invention that the system and method work for a predetermined temporal interval, such as a full year from date of each user's initial download, and then become unable to function without yearly payment. It is another object of the present invention that the application itself not be “beamable” from one PDA to another.

### SUMMARY OF INVENTION

A method and system for tracking a menstrual cycle of at least one female person using a suitable microprocessor based device, the method including: recording and saving data associated with the menstrual cycle; recording and saving information on flow associated with the menstrual cycle; recording and saving information on moods associated with the person; recording and saving notes associated with the person or menstrual cycle; and, automatically monitoring and making projections based upon at least a portion of the recorded and stored data associated the menstrual cycle.

### BRIEF DESCRIPTION OF THE FIGURES

Various other objects, features and advantages of the invention will become more apparent by reading the following detailed description of the invention and reviewing the drawings, which are shown by way of example only, wherein:

FIG. 1 illustrates a block diagram of one embodiment of the present invention; and,

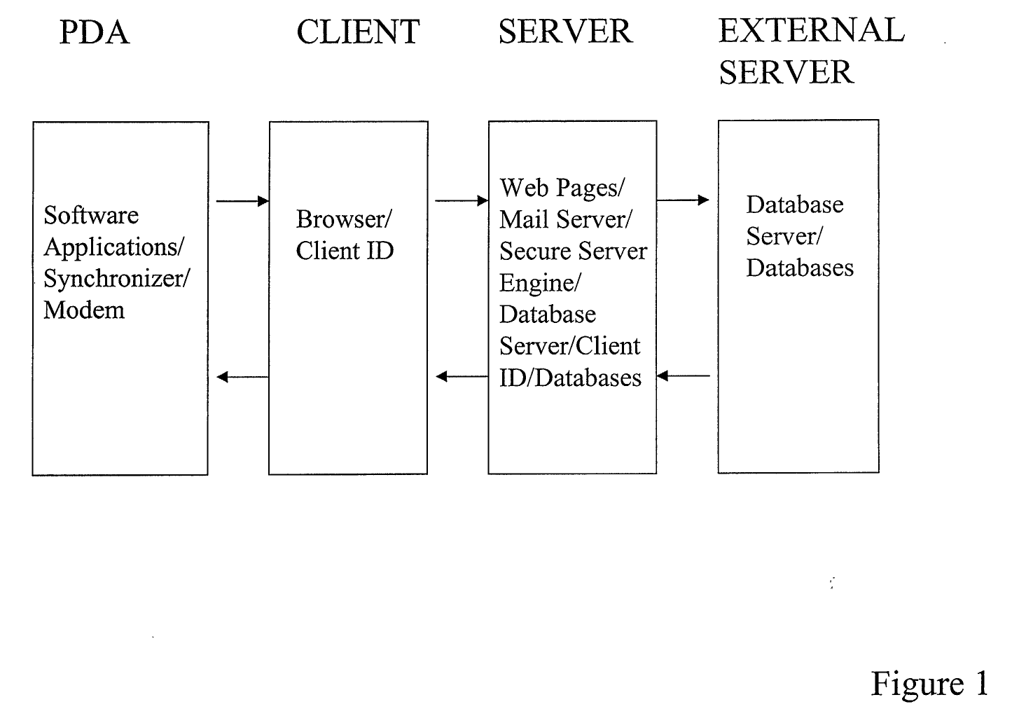

FIG. 2 illustrates a flow chart of operation according to one embodiment of the present invention.

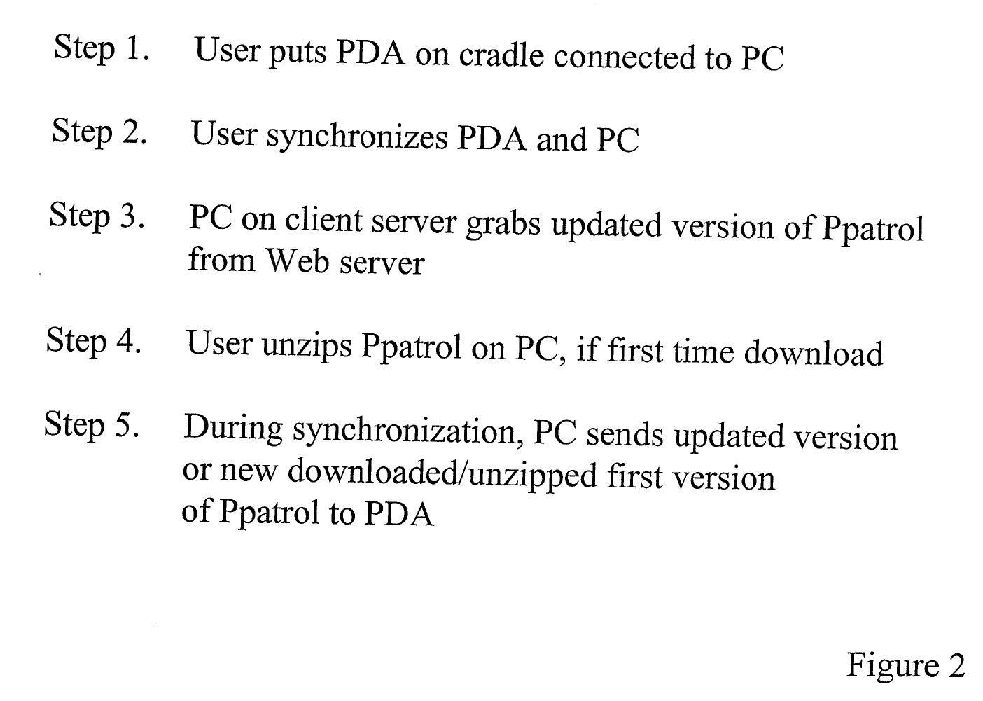

### DETAILED DESCRIPTION OF INVENTION

The present invention is referred to as pPatrol™, a trademark for a personal electronic product provided to a female end user. The product provides each end user with the capability of recording, monitoring, and projecting information pertaining to her menstrual cycle. According to one aspect of the present invention a user can download the product for use on a handheld device (PDA) from the global interconnection of computers and computer networks commonly referred to as the Internet. A synchronization function as is commonly understood can be used to synchronize data in a PDA implementation of the present invention. According to another aspect of the present invention, a separate application can be used for PC use. On a PC implementation though, there's no synchronization of PDA and PC and the user inputs information onto the PC according to yet another aspect of the present invention.

Generally, the product according to the present invention has the following capabilities and functions:

1) record, monitor, make projections on menstrual cycle including menstruation, ovulation and pregnancy;

2) record and save information on flow;

3) record and save information on moods;

4) record and save medical appointments;

5) record and save notes;

6) provide email alerts to user;

7) provide voicemail alerts to user;

8) provide capability to email physician directly from is application;

9) provide Frequently Asked Questions;

10) provide Glossary;

11) provide e-commerce portal for women's information and products;

12) provide product advisor for e-commerce portal;

13) provide “tell a friend” component (email a friend directly about application);

14) provide message board; and,

15) provide Period Diary, Birth Control Diary, OB/GYN Diary (facts and histories).

According to other aspects of the invention, the product according to the present invention can be downloaded to a PC or Apple Macintosh from a web site, can be synchronized from PC to different types of PDAs, should not be able to be “beamed” or transferred from one PDA to another, can be automatically updated during synchronization from PC to PDA, and becomes unusable after a predetermined amount of time, such as 1 year, from being downloaded or installed unless a payment is submitted for each subsequent predetermined period, such as a year, using conventional online and security methods for example.

According to another aspect of the present invention, one or more implementations of the the product according to the present invention application can be limited to:

1) record, monitor, make projections on menstrual cycle (period only);

2) record and save information on flow;

3) record and save information on moods; and,

4) record and save notes.

According to yet another aspect of the present invention, the product according to the present invention implementation includes at least the following user input screens:

1^{st} Day of Period

Allows user to select a month, day, year using a calendar

Last Day of Period

Allows a user to select a month, day, year using a calendar.

Flow

Allows a user to select one of several, for example 6, options:

Light

Light to moderate

Moderate

Moderate to heavy

Heavy

Excessive,

using a drop down menu.

Mood:

Allows a user to select any of several options:

No change, up, down, mixed, other

Notes:

Allows a user to enter text as notes.

Clear screen/About The Product According to the Present Invention

Allows a user to link to a screen of basic information about the product.

Link to:

Allows a user to link to summary screens for data previously entered and vital information.

According to yet another aspect of the present invention, the product according to the present invention implementation includes at least the following The product according to the present invention Summary screens:

1) Based on the last ______ months (drop down menu of limited number of months), my next period will begin on ______.

2) Based on the last ______ months (drop down menu of limited number of months), my period is on a ______ day cycle. [derived from simple formula and includes “variable” as one possible result]

3) Based on the last ______ months (drop down menu of limited number of months), the average length of my period is ______ days.

According to another aspect of the present invention, the predications and calculations are based on averages of previously entered data. And, if insufficient data exists to make a prediction, then a default value is provided, such as 28 days between periods. Exemplary calculations according to another aspect of the present invention are illustrated in the sole appendix hereto.

According to another aspect of the present invention, one or more implementations of the product according to the present invention application can also provide the following functionality:

1) record, monitor, make projections on ovulation and pregnancy;

2) record and save medical appointments;

3) provide email alerts to user;

4) provide voicemail alerts to user;

5) provide capability to email physician directly from application;

6) provide Frequently Asked Questions;

7) provide Glossary;

8) provide e-commerce portal for women's information and products;

9) provide product advisor for e-commerce portal;

10) provide “tell a friend” component (email a friend directly about application);

11) provide message board; and,

12) provide Period Diary, Birth Control Diary, OB/GYN Diary (facts and histories).

According to yet another aspect of the present invention, the following screens and data can also be provided.

Period Diary: Allows a user to enter information indicating a year of 1^{st} period, and special information about the user's period:

Birth Control Diary: Allows a user to enter information about what type of birth control the user uses, and other information such as a year began and a year finished.

GYN Diary: Allows a user to enter information related to a name of the user's OB/GYN, address and Phone Number, last appointment, next appointment, abortion information, and, operation information.

It is also understood that the stored information which can be downloaded from the web site can also be provided on a CD or other memory device. In this manner, the user need not access a web site, but can perform the monitoring of her cycle on her PC, laptop or hand held computer. In a similar manner, a dedicated device including a ROM can contain the stored information and having a keyboard which the user can access such information as described above and further input pertinent personal information.

In regard to the above, it is understood that the system basically operates also to provide reminders and alerts, for example. A reminder would predict when a female should expect her period based on the stored female's history or when a female should be ovulating also based on her stored history. Therefore, the system basically can operate very simply to provide reminders, alerts and predictions in regard to the menstrual cycle.

While the above-noted application concentrated on the human female, it is, of course, understood that menstrual and fertility monitors are applicable to other animals. For example, to assist breeding efforts and to enable one to determine the pertinent periods of ovulation in regard to other mammals, such as horses, dogs and so on. Therefore, the monitoring of ovulation, as well as other data is pertinent as well.

It is, of course, understood that these programs can be run on a computer as indicated above and are readable and usable to input data on a computer, as well as to store data on the computer or on the web. Therefore the system has great utility in basically monitoring and making predictions based on stored data on the menstrual cycle and based on other statistical data which has been accumulated regarding the overall population of the species concerned with.

The Appendix hereto includes one method for implementing the present invention.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed. It is intended that the patent shall cover by suitable expression in the appended claims, whatever features of patentable novelty exist in the invention disclosed.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for tracking a menstrual cycle of at least one female person using a suitable microprocessor based device, said method comprising:
storing information associated with said menstrual cycle;
storing and saving information on flow associated with the menstrual cycle;
storing information on moods associated with the person;
storing notes associated with the person or menstrual cycle; and,
automatically monitoring and making projections based upon at least a portion of the stored information associated the menstrual cycle.

2. Apparatus for monitoring the menstrual cycle of a predetermined individual comprising:
a memory for storing information related to said menstrual cycle and generated from statistical data,
an input device for inputting information related to said individual as associated with said individual's cycle and,
means for predicting menstrual events based on associating said input information with said stored information.

3. The apparatus according to claim 2 where said input information is selected from flow, mood and medical appointments.

4. The apparatus according to claim 2 wherein said memory for storing includes a memory located at a remote server and accessible by said individual via the Internet.

5. The apparatus according to claim 4 further including a personal computer device associated with said user and capable of downloading said stored data via the Internet.

6. The apparatus according to claim 5 wherein said personal device is a PC.

7. The apparatus according to claim 5 wherein said personal device is a PDA.

8. The apparatus according to claim 2 wherein said means for predicting menstrual events includes means for predicting menstruation dates, ovulation dates and pregnancy.

9. The apparatus according to claim 4 further indicating means located at said remote server for storing information inputted by said user when connected to said remote server via the Internet.

10. The apparatus according to claim 9 wherein said individual information as stored at said remote server includes information selected from the following:
name and address of said user's physician as well as appointment information,
facts and history regarding said user's menstrual cycle history.
